(19) United States
(12) Patent Application Publication
(10) Pub. No.: US 2014/0098986 A1
(43) Pub. Date: Apr. 10, 2014

(54) Systems and Methods for Performing Video Analysis

(71) Applicant: THE PROCTER & GAMBLE COMPANY, Cincinnati, OH (US)

(72) Inventors: Nick Robert Harrington, Boston, MA (US); Robb Olsen, Cincinnati, OH (US); David Matsumoto, Richmond, CA (US); Hyi Sung Hwang, Berkeley, CA (US)

(73) Assignee: The Procter & Gamble Company, Cincinnati, OH (US)

(21) Appl. No.: 13/646,860

(22) Filed: Oct. 8, 2012

(51) Int. Cl. G06K 9/00

(52) U.S. Cl. 382/100

(57) ABSTRACT

Included are embodiments for performing video analysis. Some embodiments include a system with a memory component that stores logic that, when executed by the system, causes the system to receive video content of a subject, identify a mannerism of the subject at a point in time in the video content, and determine an emotional state associated with the mannerism. In some embodiments, the logic causes the system to receive a file that correlates the mannerism with the point in time and provide a user interface that provides the video content with data from the file, such that the mannerism is provided with the data.

### FIELD OF THE INVENTION

The present application relates generally to systems and methods for providing a video analysis and specifically to utilizing emotional state data of a subject in a video and providing an interface to convey that data.

### BACKGROUND OF THE INVENTION

Companies often perform market research to determine a consumer reaction to various everyday problems, as well as the effectiveness of a stimulus in solving those problems. While this market research has historically taken the form of consumer surveys, live test groups, etc., oftentimes these traditional market research tools are inefficient or do not provide enough data to accurately capture the desired data.

### SUMMARY OF THE INVENTION

Included are embodiments of a system with a memory component that stores logic that, when executed by the system, causes the system to receive video content of a subject, identify a mannerism of the subject at a point in time in the video content, and determine an emotional state associated with the mannerism. In some embodiments, the logic causes the system to receive a file that correlates the mannerism with the point in time and provide a user interface that provides the video content with data from the file, such that the mannerism is provided with the data.

Also included are embodiments of a method. Some embodiments of the method include receiving video content of a subject, the video content comprising the subject interacting with a stimulus, identifying a mannerism of the subject at a point in time in the video content when the subject interacts with the stimulus, and determining an emotional state associated with the mannerism. In some embodiments, the method includes receiving a file that correlates the mannerism with the point in time and providing a user interface that provides the video content with data from the file, such that the mannerism is provided with the data, wherein the user interface further provides an emotional state value.

Also included are embodiments of a non-transitory computer-readable medium. Some embodiments of the non-transitory computer-readable medium include logic that, when executed by a computing device, causes the computing device to receive video content of a subject, the video content comprising the subject interacting with a stimulus and identify a facial expression of the subject at a point in time in the video content when the subject interacts with the stimulus. In some embodiment, the logic causes the computing device to determine an emotional state associated with the facial expression, receive a file that correlates the facial expression with the point in time, and provide a user interface that provides the video content with data from the file, such that the facial expression is provided with the data, wherein the user interface further provides an emotional state value.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 depicts a computing environment for performing video analysis, according to embodiments disclosed herein;

FIG. 2 depicts a user computing device for performing the video analysis, according to embodiments disclosed herein;

FIG. 3 depicts a user interface that may be provided for selecting a video file and a data file for performing the video analysis, according to embodiments disclosed herein;

FIG. 4 depicts a user interface that may be provided for analyzing video content, according to embodiments disclosed herein;

FIG. 5 depicts a user interface that may be provided for creating a bookmark for video content, according to embodiments disclosed herein;

FIG. 6 depicts a user interface that may be provided for creating an automatic bookmark, according to embodiments disclosed herein; and

FIG. 7 depicts a flowchart for performing video analysis, according to embodiments disclosed herein.

### DETAILED DESCRIPTION OF THE INVENTION

Embodiments disclosed herein include systems and methods for performing video analysis. Specifically, embodiments disclosed herein may be configured to determine an emotional state of a subject at one or more points in time in a video. The emotional state and the video content may additionally be provided within a user interface such that the user can play the video content and view the identified emotional states via indicators that are provided at the point in time or a plurality of points in time where the emotional state is detected. Embodiments disclosed herein also provide options for bookmarking various portions of the video content to easily recall the identified emotional states at a later time.

Additionally, some embodiments may be configured to create summary statistics, such as data tables and graphs from single or multiple time periods from a video and/or multiple time points from multiple videos and/or subjects. This allows the system to quickly summarize responses from the same subject in response to a stimulus and/or to different stimuli (e.g., products, digital images, physical images, still images, animated images, a discussion of an experience, etc.) and/or a plurality of subjects to the same stimuli. Embodiments may also be configured to store data from sharing among different computing devices.

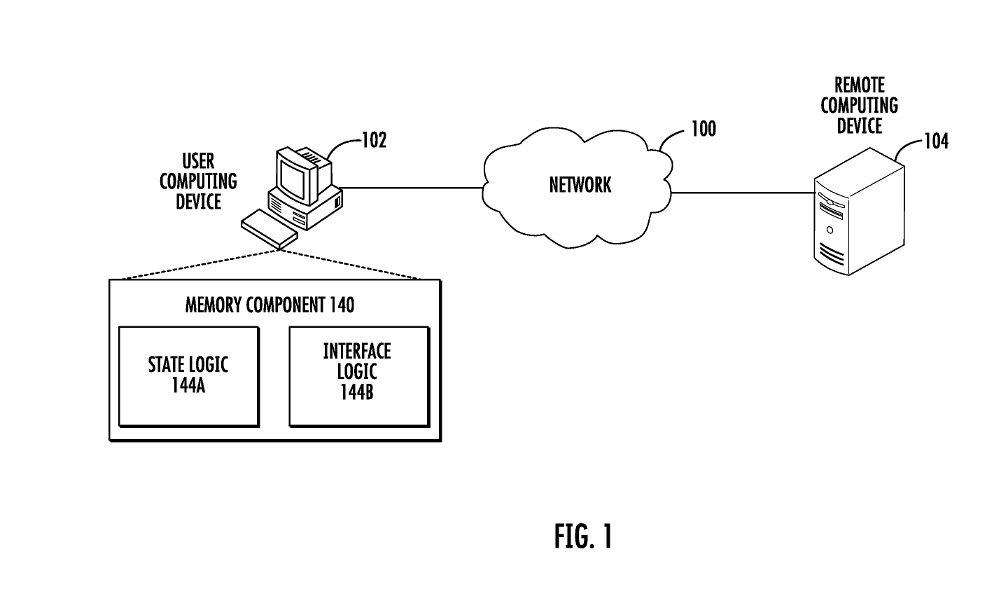

Referring now to the drawings, FIG. 1 depicts a computing environment for performing video analysis, according to embodiments disclosed herein. As illustrated, a network 100 may be coupled to a user computing device 102 and a remote computing device 104. The network 100 may include any wide area and/or local area network, such as the internet, a mobile communications network, a satellite network, a public service telephone network (PSTN) and/or other network for facilitating communication between devices. If the network 100 includes a local area network, the local area network may be configured as a corporate network, school network, and/or other open or closed network that is coupled to a wide area network.

Accordingly, the user computing device 102 may include a personal computer, laptop computer, tablet, mobile computing device, mobile communications device, database, and/or other computing device operated by a corporate employee or other entity. The user computing device 102 includes a memory component 140, which stores state logic 144a and interface logic 144b. The state logic 144a may be configured to determine an emotional state of a subject in a video, as well as determine other information, such as determining a point in time that the emotional state occurred in the video, and/or other determinations. As discussed in more detail below, the state logic 144a may cause the user computing device 102 to accomplish these tasks internally or may accomplish these tasks by receiving the data from an external source, such as from the remote computing device 104 or other source. The interface logic 144b may cause the user computing device 102 to provide an interface that correlates the video content with the emotional state data, such that the user can determine the stimuli for creating the emotional state.

The remote computing device 104 may be configured to determine the emotional state of a subject in the video content. While in some embodiments the user computing device 102 can make this determination, in some embodiments, the video content is sent by the user computing device 102 to the remote computing device 104 for this purpose. In such embodiments, the remote computing device 104 may return a text file or other electronic document that the user computing device 102 can utilize for assembling the user interfaces and correlating the video content with the text file.

It should be understood that while the user computing device 102 is depicted as a single personal computer and the remote computing device 104 is depicted as a single server, these are merely examples. Specifically, the user computing device 102 may include one or more personal computers, servers, laptops, tablets, mobile computing devices, data storage devices, etc. that are configured for providing information to a user. Similarly, the remote computing device 104 may include one or more servers, personal computers, laptops, tablets, mobile computing devices, data storage devices, etc. for determining the emotional state and other data discussed herein.

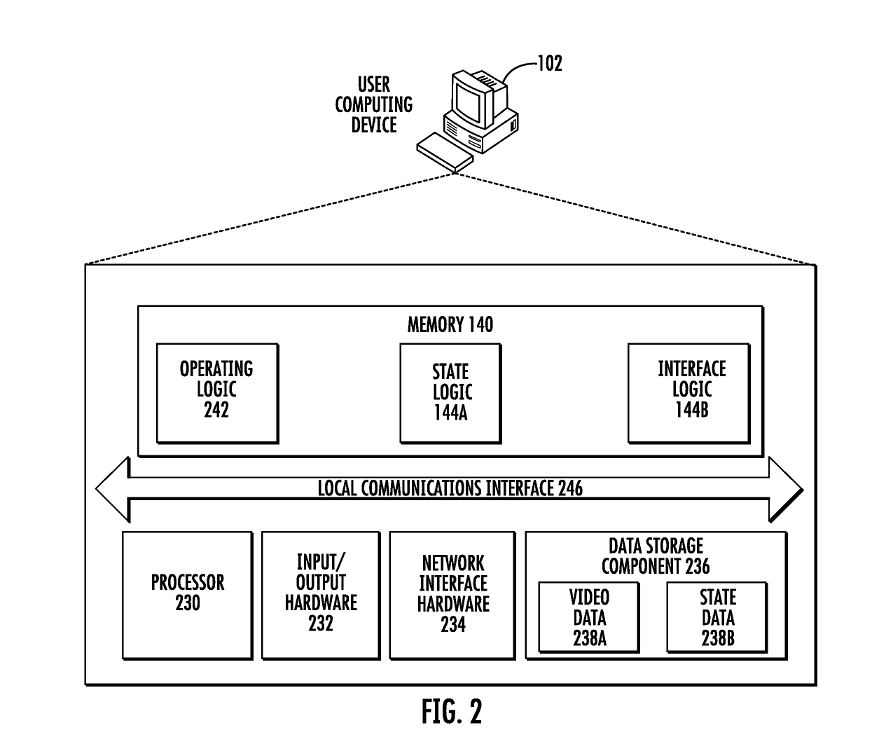

FIG. 2 depicts a user computing device 102 for performing the video analysis, according to embodiments disclosed herein. In the illustrated embodiment, the user computing device 102 includes a processor 230, input/output hardware 232, network interface hardware 234, a data storage component 236 (which stores video data 238a and state data 238b), and the memory component 140. The memory component 140 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular embodiment, the non-transitory computer-readable medium may reside within the user computing device 102 and/or external to the user computing device 102.

Additionally, the memory component 140 may be configured to store operating logic 242, the state logic 144a, and the interface logic 144b, each of which may be embodied as a computer program, firmware, and/or hardware, as an example. A local communications interface 246 is also included in FIG. 2 and may be implemented as a bus or other interface to facilitate communication among the components of the user computing device 102.

The processor 230 may include any processing component operable to receive and execute instructions (such as from the data storage component 236 and/or memory component 140). The input/output hardware 232 may include and/or be configured to interface with a monitor, keyboard, mouse, printer, camera, microphone, speaker, and/or other device for receiving, sending, and/or presenting data. The network interface hardware 234 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the user computing device 102 and other computing devices.

Similarly, it should be understood that the data storage component 236 may reside local to and/or remote from the user computing device 102 and may be configured to store one or more pieces of data for access by the user computing device 102 and/or other components. In some embodiments, the data storage component 236 may be located remotely from the user computing device 102 and thus accessible via the network 100. In some embodiments however, the data storage component 236 may merely be a peripheral device, but external to the user computing device 102.

Included in the memory component 140 are the operating logic 242, the state logic 144a, and the interface logic 144b. The operating logic 242 may include an operating system and/or other software for managing components of the user computing device 102. Similarly, the state logic 144a may be configured to cause the user computing device 102 to utilize the video data 238a for determining an emotional state of the subject. The determined emotional state may be stored as the state date 238b, which may then be provided as an interface via the interface logic 144b. The interface logic 144b may cause the user computing device 102 to provide the user interfaces, as well as receive and respond to inputs from the user.

It should be understood that the components illustrated in FIG. 2 are merely exemplary and are not intended to limit the scope of this disclosure. While the components in FIG. 2 are illustrated as residing within the user computing device 102, this is merely an example. In some embodiments, one or more of the components may reside external to the user computing device 102.

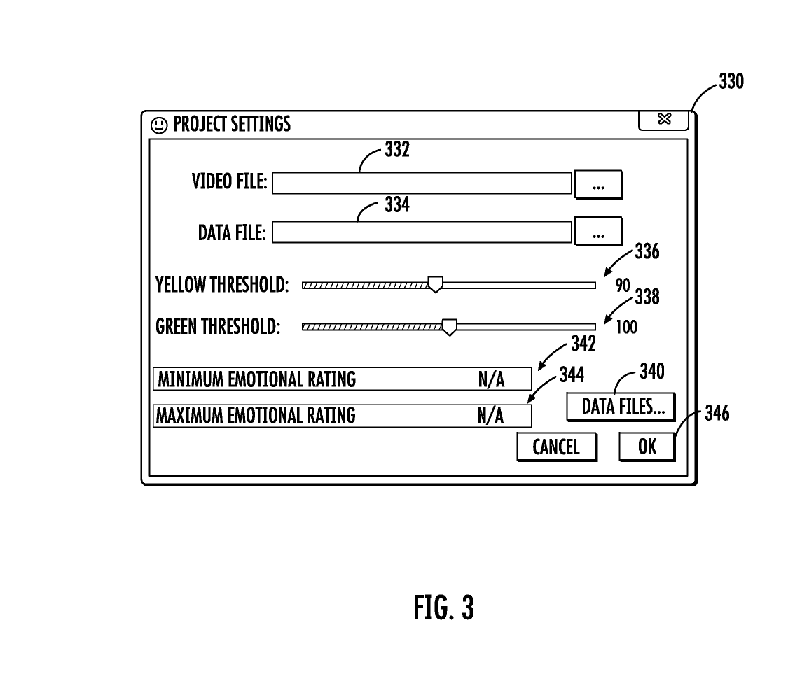

FIG. 3 depicts a user interface 330 that may be provided for selecting a video file and a data file for performing the video analysis, according to embodiments disclosed herein. As illustrated, the user computing device 102 may provide the user interface 330 for opening a video file that may be stored on the user computing device 102, the remote computing device 104 and/or elsewhere. A location of the video content may be entered in a video file field 332. Additionally, the user may specify a data file in a data file option 334. Specifically, the user may identify the video content and the corresponding data file that correlates determined emotional states to a point in time of the video content.

Also included are a yellow threshold option 336 and a green threshold option 338. As discussed in more detail, below, the user computing device 102 may be configured to correlate the video content with an accuracy determination of the determined emotional states of a user in the video content. Additionally, a probability of accuracy of the determined emotional states may be visually signified with a color indicator to provide the user with a mechanism for quickly and easily identifying whether the determined emotional state is most likely accurate, neutrally, accurate, or not likely accurate. Accordingly, the yellow threshold option 336 may be utilized to identify the boundary between the probability that a determined emotional state being neutrally accurate or not likely accurate. The green threshold option 338 may be utilized to identify the boundary between the determined emotional state being likely accurate or neutrally accurate.

Also included in the user interface 330 is an a min rating option 342 to identify the minimum emotional rating value that will be recorded and a max rating option 344 to identify the maximum emotional rating value that will be recorded. Specifically, once a data file has been selected, the min rating option 342 and the max rating option 344 will populate to show the range of emotion exhibited by the subject in the video content.

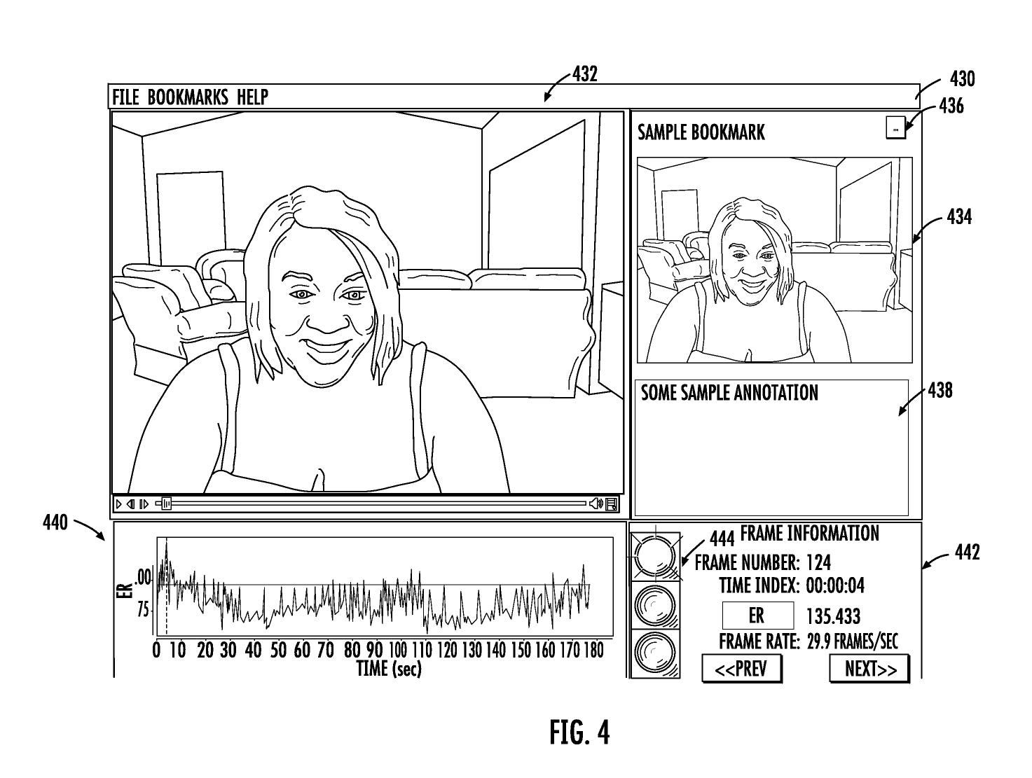

Also is a secondary data file option 340 for identifying a secondary data file that may be compared with the data file identified in the data file option 334. As an example, the user computing device 102 may create a data file that determines emotional states exhibited by the subject in the video content and correlates those determined emotional states with corresponding points in time in the video content. Additionally, the video content may be sent to the remote computing device 104 for making a similar determination. Accordingly, in such an example, the data file as determined by the user computing device 102 may be identified in the data file option 334, while the data file as determined by the remote computing device 104 may be identified in the secondary data file option 340. The two data files may thus be provided in the user interface 430, depicted in FIG. 4. A save option 346 is also included in the user interface 330 to save the current settings.

FIG. 4 depicts a user interface 430 that may be provided for analyzing video content, according to embodiments disclosed herein. As illustrated, the user interface 430 includes a video content section 432, bookmark section 434, which includes a bookmark options 436a, 436b and an annotation section 438. A data section 440 is also included, as well as a frame information section 442, which includes a frame state indicator 444 and at least one find bookmark option 448 for locating a next or previous bookmark. The video content section 432 includes a video scroll option 446 for allowing the user to scroll to a predetermined point in the video content.

The video content section 432 may provide video content of a subject that is interacting with a stimulus. As an example, a subject may be recorded viewing or interacting with a stimulus. The stimulus may be given to the subject as part of a consumer test or may simply be part of a shopping experience for the subject. Regardless, after the video content is captured, the video content may be analyzed to identify a mannerism, such as a facial expression, hand gesture, body position, posture, etc. of the subject and a point in time that the mannerism occurred. Additionally, an emotional state may be determined from the identified mannerism.

Accordingly, the video content section 432 may provide the captured video content to the user. Additionally, a graphical representation of the emotional response of the subject may be provided in the data section 440. Specifically, upon determining the emotional state of the subject, an emotional state value may be determined and graphically (and/or numerically) provided as to whether the emotional state is a positive, negative, or neutral state. Specifically, the emotional state may be determined as a probability of being one of the archetypal emotions (plus true happiness versus social smile versus neutrality). Thus, as the video content is played, an indicator in the data section 440 may identify the ranking may be provided. Similarly, as the user makes a user selection or manipulates the scroll option or indicates a selected point of the video content to view, video may skip to the selected point and the indicator in the data section 440 may advance with the video scroll option 446.

Similarly, the frame information section 442 includes the frame state indicator 444. As defined by the yellow threshold option 336 and the green threshold option 338 in FIG. 3, the frame state indicator 444 can flash green, yellow, and/or red (or other colors/identifiers) based on whether the accuracy of a determined emotional state is likely accurate. Also provided in the frame information section 442 are a frame number, time index, emotional rating, and a frame rate.

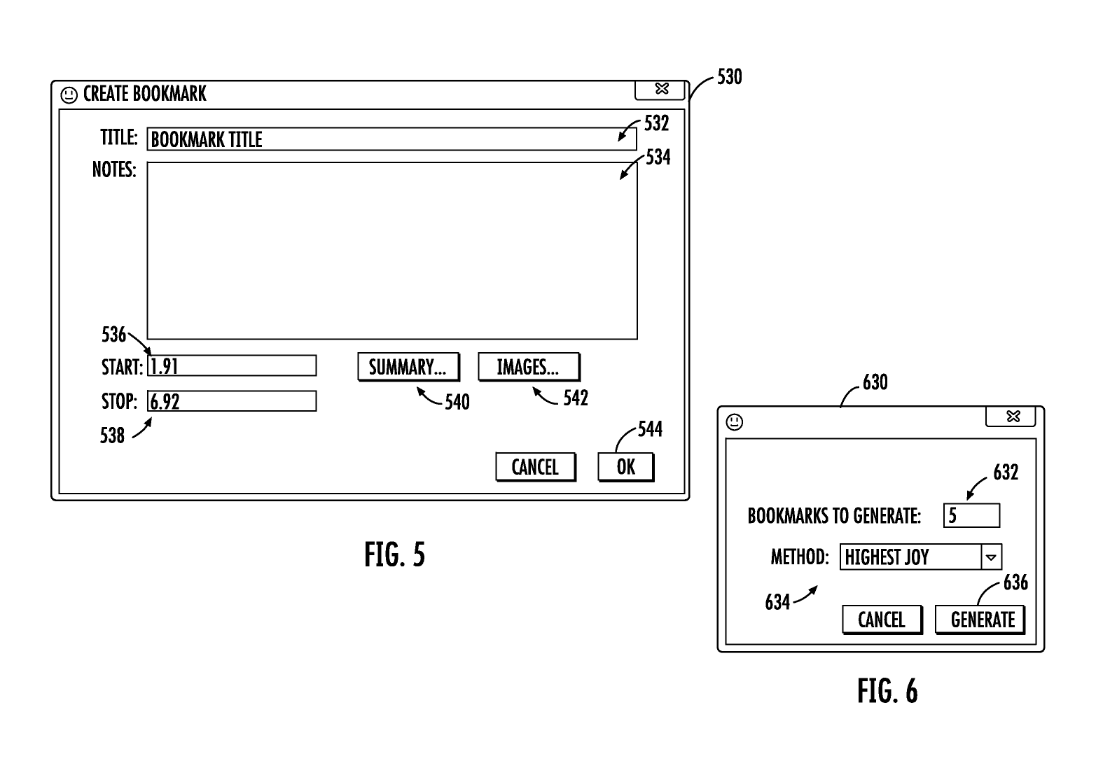

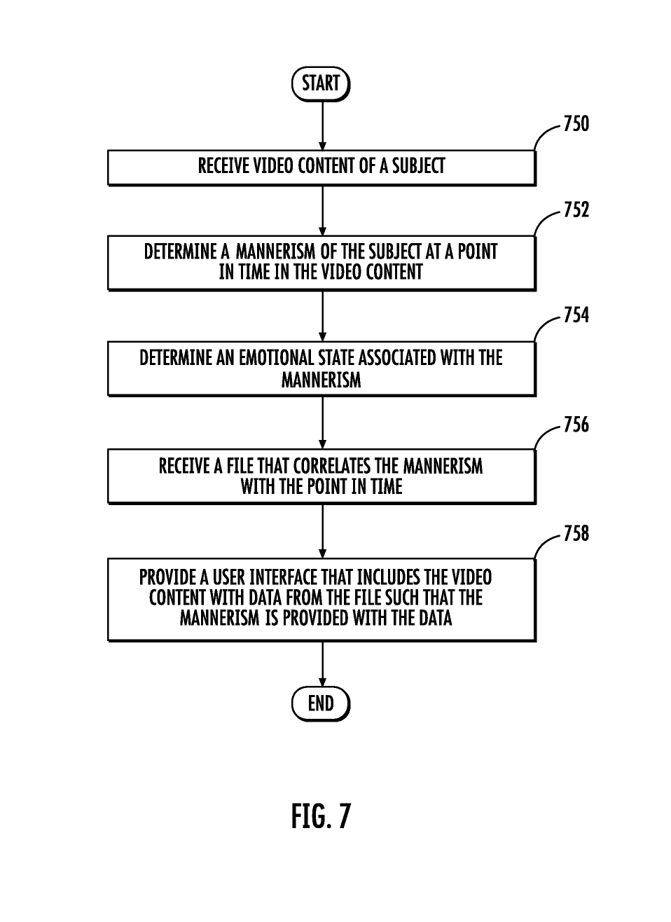

The user interface 430 also includes the bookmark section 434. Specifically, if the user desires to create a bookmarked point for later use, the user may input an annotation into the annotation section 438 and select the bookmark option 436a. This will create a marker for that point in time of the video content to retrieve later and direct the user to additional options, as depicted in FIG. 5. Similarly, in response to selection of the bookmark option 436b, the user may be provided with options to create an automatic bookmark, as discussed in more detail with regard to FIG. 6. The bookmark may be exported with one or more images from the video content, emotional response data from the associated images, and/or the emotional response trace animated over the video content. Additionally, the bookmark may be annotated with a still image of the stimulus that is presented to the consumer, which may result in the determined emotional response.

FIG. 5 depicts a user interface 530 that may be provided for creating a bookmark for video content, according to embodiments disclosed herein. As illustrated, in response to selection of the bookmark option 436a, a bookmark may be crated and the user may be provided with the user interface 530. The user interface 530 includes a title prompt 532, a notes prompt 534, a start field 536, a stop field 538, a summary option 540, an images option 542, and a save option 544.

Specifically, the user may enter a title of the bookmark in the title prompt 532. The user may additionally input any notes or comments in the notes prompt 534. The start field 536 and the stop field 538 may identify when the bookmark starts and stops. While the user may graphically identify start and stop points of the bookmark in the user interface 430 (FIG. 4), this provides the user with the option to determine bookmark start and stop points textually. Also included is the summary option 540, which provides information related to the details of the emotional state captured in the bookmark As an example, the emotional ranking value, confidence, emotional state, and/or other information may be provided. Similarly, still images from the video content may be captured and provided in response to a user selection of the images option 542. The bookmark may be saved by selecting the save option 544.

FIG. 6 depicts a user interface 630 that may be provided for creating an automatic bookmark, according to embodiments disclosed herein. In response to selection of the bookmark option 436b from FIG. 4, the user interface 630 may be provided for creating automatic bookmarks. Specifically, a user may wish to bookmark all emotional states that reach a positive emotional state threshold, a negative emotional state threshold, etc. Specifically, the bookmarks may be created when the probability of an emotional state reaches the threshold. As a consequence, a number field 632 may be provided for the user to identify the number of bookmarks that will be generated. A method option 634 may be provided for the user to identify a classification of a preferred emotional state that the user wishes to bookmark. A non-exhaustive list of emotional states includes anger, contempt, disgust, fear, sadness, surprise, and happiness (such as social happiness and true happiness, which may be indicated by Duchene and non-Duchene smiles, respectively), and degrees of the emotional state. As an example, the user may select to only bookmark a highest level of happiness (or joy). In response to selection of a generate option 636, the bookmarks may be generated.

It should be understood that in some embodiments, the user computing device 102 (FIG. 1) may be configured to receive the video content, determine the mannerisms, and identify the emotional states associated with those mannerisms, this is just an example. Depending on the particular embodiment, the computing device 102 may determine one or more emotional states associated with the video content substantially simultaneously, including indicating a probability that any one of the determined emotional states is the one experienced. However, in some embodiments, the video content may be sent to the remote computing device 104 or to another external source to determine the emotional states. Accordingly, the user computing device 102 may receive the video content and an electronic file that identifies the emotional state and the point in time of the video content that the emotional state occurs. Accordingly, the user computing device 102 may correlate the video content with the data file so that the user may view the identified emotional state concurrently with the video content in the user interface 430 of FIG. 4.

FIG. 7 depicts a flowchart for performing video analysis, according to embodiments disclosed herein. As illustrated in block 750, the video content of a subject may be retrieved. In block 752, a mannerism of the subject may be determined at a point in time in the video content. As discussed above, this determination may be made by the user computing device 102 and/or the remote computing device 104. Regardless, in determining the mannerism or other mannerisms, a video analysis may be performed that identifies movements in the mouth, eyes, cheeks, complexion, change in voice, and/or other facial or body gestures. In block 754, an emotional state associated with the mannerism may be determined. Specifically, based on the identified mannerism, a determination may be made regarding the emotional state of the subject. In block 756, a file that correlates the mannerism with the point in time may be received. As discussed above, this file may be received from the remote computing device 104 and/or may be created by the user computing device 102, where received indicates that the file is accessed for use in the user interface 430 (FIG. 4). In block 758, a user interface may be provided that includes the video content with data from the file such that the mannerism is provided with the data.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. A system for performing video analysis, comprising:
a memory component that stores logic that, when executed by the system, causes the system to perform at least the following:
receive video content of a subject;
identify a mannerism of the subject at a point in time in the video content;
determine an emotional state associated with the mannerism;
receive a file that correlates the mannerism with the point in time; and
provide a user interface that includes the video content with data from the file, such that the mannerism is provided with the data.

2. The system of claim 1, wherein the emotional state comprises at least one of the following: anger, contempt, disgust, fear, sadness, surprise, social happiness, and true happiness.

3. The system of claim 1, wherein the logic further causes the system to perform at least the following:
determine an emotional state value of the subject at the point in time; and
provide the emotional state value in the user interface.

4. The system of claim 3, wherein the logic further causes the system to perform the following:
determine a graphical representation of the emotional state value for a plurality of points in time in the video content; and
provide the graphical representation in the user interface.

5. The system of claim 4, wherein the logic further causes the system to perform the following:
receive a user selection of a section of the graphical representation; and
provide the video content at a selected point in time that corresponds with the user selection.

6. The system of claim 1, wherein the logic further causes the system to provide a bookmark option, wherein in response to a user selection of the bookmark option, the system identifies a bookmarked point in time of the video content.

7. The system of claim 6, wherein the logic further causes the system to provide a find bookmark option, wherein in response to selection of the find bookmark option, the system provides the video content at the bookmarked point in time.

8. A method for performing video analysis, comprising:
receiving video content of a subject, the video content comprising the subject interacting with a stimulus;
identifying a mannerism of the subject at a point in time in the video content when the subject interacts with the stimulus;
determining, by a computing device, an emotional state associated with the mannerism;
receiving a file that correlates the mannerism with the point in time; and
providing a user interface that provides the video content with data from the file, such that the mannerism is provided with the data, wherein the user interface further provides an emotional state value.

9. The method of claim 8, wherein the emotional state comprises at least one of the following: anger, contempt, disgust, fear, sadness, surprise, social happiness, and true happiness.

10. The method of claim 8, further comprising:
determining a graphical representation of the emotional state value for a plurality of points in time in the video content; and
providing the graphical representation in the user interface.

11. The method of claim 10, further comprising:
receiving a user selection of a section of the graphical representation; and
providing the video content at a selected point in time that corresponds with the user selection.

12. The method of claim 8, further comprising providing a bookmark option, wherein in response to a user selection of the bookmark option, the system identifies a bookmarked point in time of the video content.

13. The method of claim 12, further comprising providing a find bookmark option; and
in response to selection of the find bookmark option, providing the video content at the bookmarked point in time.

14. The method of claim 8, further comprising automatically creating a bookmark for the video content, wherein automatically creating the bookmark comprises identifying a preferred emotional state and a number of bookmarks to create.

15. A non-transitory computer-readable medium for performing video analysis that includes logic, that when executed by a computing device, causes the computing device to perform at least the following:
receive video content of a subject, the video content comprising the subject interacting with a stimulus;
identify a facial expression of the subject at a point in time in the video content when the subject interacts with the stimulus;
determine an emotional state associated with the facial expression;
receive a file that correlates the facial expression with the point in time; and
provide a user interface that provides the video content with data from the file, such that the facial expression is provided with the data, wherein the user interface further provides an emotional state value.

16. The non-transitory computer-readable medium of claim 15, wherein the emotional state comprises at least one of the following: anger, contempt, disgust, fear, sadness, surprise, social happiness, and true happiness.

17. The non-transitory computer-readable medium of claim 15, the logic further causing the computing device to perform the following:
determine a graphical representation of the emotional state value for a plurality of points in time in the video content;
provide the graphical representation in the user interface;
receive a user selection of a section of the graphical representation; and
provide the video content at a selected point in time that corresponds with the user selection.

18. The non-transitory computer-readable medium of claim 15, the logic further causing the computing device to provide a bookmark option, wherein in response to a user selection of the bookmark option, the system identifies a bookmarked point in time of the video content.

19. The non-transitory computer-readable medium of claim 18, the logic further causing the computing device to perform the following:
provide a find bookmark option, and
in response to selection of the find bookmark option, provide the video content at the bookmarked point in time.

20. The non-transitory computer-readable medium of claim 15, the logic further causing the computing device to automatically create a bookmark for the video content, wherein automatically creating the bookmark comprises identifying a preferred emotional state and a number of bookmarks to create.
